(19) United States
(12) Patent Application Publication
(10) Pub. No.: US 2003/0044749 A1
(43) Pub. Date: Mar. 6, 2003

(54) Stable dental analog systems

(76) Inventor: Leonard Marotta, West Islip, NY (US)

Correspondence Address: ALFRED M. WALKER, 225 OLD COUNTRY ROAD, MELVILLE, NY, 11747-2712, US

(21) Appl. No.: 10/232,498

(22) Filed: Aug. 30, 2002

Related U.S. Application Data
(63) Continuation-in-part of application No. 10/056,101, filed on Jan. 24, 2002.
(60) Provisional application No. 60/316,832, filed on Aug. 31, 2001.
(60) Provisional application No. 60/402,187, filed on Aug. 10, 2002.

(51) Int. Cl. A61C 9/00; A61C 8/00

(52) U.S. Cl. 433/45; 433/173

(57) ABSTRACT

A stable dental prosthesis system includes transparent guides with radio opaque markers therein to accurately position an implant in a jaw. To make the prosthesis for the implant, an implant analog is used with an abutment that can be mounted in the dental lab replica of the relevant section of a patient's mouth securely. The analogs have a pin or other protrusion that projects from the base of the analog. The system also includes a perforated tray for accommodating protruding implant impression copings therethrough when the impression mold is made of the dental patient's mouth. A generally flat articulation wafer connects one impression of one jaw to an opposing wax impression of an opposite jaw, so that upper and lower prosthesis are in positional register. A flexible frame may also be provided for temporary teeth before osseointegration of the implant with the jaw bone.

### RELATED APPLICATIONS

This application is based in part upon U.S. Provisional Patent Application No. 60/316,832 filed Aug. 31, 2001, upon U.S. patent application Ser. No. 10/056,101, filed Jan. 24, 2002 and upon U.S. Provisional Patent Application No. 60/402,187 filed Aug. 10, 2002.

### FIELD OF THE INVENTION

This invention relates generally to the construction of a stable and precise dental prosthesis that is attached to an implant in the bone of a person's jaw.

### BACKGROUND OF THE INVENTION

Dental implants are a common treatment for the replacement of a missing tooth or missing teeth. An implant is placed into the bone in a person's jaw in a variety of fashions and using a variety of systems. The bone and the implant adhere together in a process known as osseointegration, thus enabling a person to have a new tooth or set of teeth held into position in the jaw utilizing screws to hold them down.

Many firms manufacture complete systems of dental implants and prosthetic components for subsequent attachment to the implant. In a typical construction, the implant has an axially threaded hole at its top, that is, the proximal end, near the gum surface. After the implant has integrated with the bone, the gum of the implant is opened to expose the tapped hole. Then a transmucosal abutment is attached to the tapped hole of the implant and extends to a level above the gum or substantially to the gum surface. The protruding free end of the abutment is constructed for attachment of a prosthesis. For preventing rotation of the prosthesis, the protruding end of the abutment requires a non-round shape and a hexagon protrusion has been widely used. A recessed hexagon is also popular with some systems. The abutment also includes a central threaded hole concentric with the threaded hole of the implant and extending inward toward the jawbone.

A false tooth or frame is provided with a hole therethrough, known in the industry as a chimney, and a non-round recess in its base corresponds in shape to the protruding non-round cross section for the abutment. Thereby, the crown can be connected to the abutment and relative rotation between them is prevented so long as critical contours of the abutment and the recess in the crown are maintained.

However, existing prosthesis frames are usually stationary and non-adjustable.

To prevent the crown or bridge from lifting axially from the abutment, a final screw is passed into the chimney opening and engages the tapped hole in the implant by way of the abutment so as to hold the crown axially to the abutment and to the implant. Thus, the crown cannot rotate about the abutment or implant because it is mated with the special contours on the exposed end of the abutment. The abutment is similarly mated to the proximal or outer end of the implant. The crown cannot pull away from the abutment when the screw has been tightened into place.

Finally, the chimney above the screw is filled with a composite material that hardens and is shaped as part of the crown to look like a natural tooth.

There are many variations in construction.

In an alternative method, the crown is attached directly to a non-round protrusion of the implant and is held directly to the implant by a gold screw without use of an intermediate abutment.

The implant is intended to be a permanent fixture in the jawbone. The abutment and crown may be replaced if necessary due to damage or poor fit by gaining access to the screw head by way of the chimney, and backing off the screw so that the crown and abutment or crown to the implant can be separated from the implant. Thus repairs may be made of an abutment and crown with no or little inconvenience.

Therefore, the fit of an implant with the crown or frame must be perfect. If a prosthesis is placed into the mouth and does not seat precisely and correctly, the implant or abutment can be damaged. If an implant is damaged there are not many options for its repair. In cases where there has been a poor fit, the screws have broken inside the abutment requiring the replacement of the abutment. There have been cases where the screw broke inside the implant. The implants cannot be replaced without surgically removing them. Placing a new implant in the same spot is not an advised option.

Among related patents disclosing dental analogs include U.S. Pat. No. 6,142,782 of Lazarof, which shows a dental analog with annular wings. However, the annular wings do not hinder rotating and therefore misplacement of the analog within the replica cast stone. The annular wings of Lazarof do not intersect with the cast stone material enough to prevent rotation.

### OBJECTS OF THE INVENTION

Accordingly, it is the object of the invention to provide a method for insuring the most accurate and precise seating possible of a prosthesis to an abutment or implant.

It is also and object of the present invention to assist a dentist in accurately locating a site and orientation for a dental implant.

It is further an object of the present invention to provide a prosthesis impression tray which accommodates protruding implant copings therethrough.

It is also an object of the invention to provide an adjustable internal frame for a dental prosthesis which connects the prosthesis to an abutment connected to a dental implant, or directly to a dental implant, for insuring the most accurate seating possible of a prosthesis to an abutment or implant.

It is a further object of the present invention to provide an interim flexible provisional prosthesis frame for immediate post-implant surgery use during tissue healing.

It is yet another object of the present invention to provide a method of making a dental prosthesis, which takes into account opposing biting surfaces of the dental prosthesis.

It is also another object of the present invention to provide a strong abutment with minimal use of metal materials.

It is still another object of the present invention to be able to clean and polish dental prostheses without damaging implant abutment joints thereof.

### SUMMARY OF THE INVENTIONS

The present invention comprises a stable dental analog system; including a novel split and perforated impression tray holding an impression in the mouth and accommodating protruding impression copings therethrough. The system also includes transparent surgical guides and stents for precisely locating and placing a dental implant in the mouth of a patient. Additionally, at first stage surgery, to accommodate tissue swellings, an interim provisional restoration is provided with adjustable and/or flexible frames. In certain circumstances, if the prosthesis is strong enough above the flexible frame, it can become a permanent final restoration.

Moreover, the system provides for intra oral or extra oral interim direct abutments connecting the implant to an upper or lower prosthesis. These novel abutments minimize material use while maintaining stability. To make a prosthesis with artificial teeth an exact replica of the position of the implant and tooth above the implant must be precisely located. To achieve this precise implant location, an implant analog may include a standard abutment that can be mounted in the dental lab replica of the relevant section of a patient's mouth more securely than heretofore possible. Because of the inventive implant analog, dental labs can now create a crown that will attach more accurately to the implant in the patient's mouth. The analogs of the present invention are desirably longer than the analogs used heretofore and have a pin that projects from the base of the analog. Desirably, the inventive analogs have a side ridge. Moreover, the analog has substantially the same height and dimensions as a conventional implant and abutment. In a preferred embodiment, the analog of the present invention is formed from stainless steel.

In addition to the aforementioned use of precise replica analogs of actual dental implants in making an impression cast for producing a dental prosthesis, the present invention also provides transparent guides shaped like the patient's gums and remaining teeth, with one or more radio-opaque markers, such as barium sulfate or other materials, therein for determining the precise location and orientation of the proposed site of an implant in the patient's jaw. These transparent guides, preferably made of transparent resins and thermoplastic resins, can also include cylindrical tubular sleeves for accommodating implant drills in the precise location and orientation where drilling is to take place in the patient's jaw.

Moreover, after the implant is surgically inserted into the jawbone, it may take months for proper osseo-integration of the artificial implant with the natural bone tissues of the jaw, and for healing of surgically disrupted soft gum tissues. Therefore the present invention also includes the use of provisional interim immediate post surgery flexible frames with temporary teeth for the patient during the extended healing process. Such interim prosthesis frames may be made of flexible metals, such as nitinol or flexible plastics, such as acrylics.

In certain circumstances, given the strength of the composite or ceramic material forming the prosthesis, the interim prosthesis may be strong enough to be a final permanent prosthesis. However, if made with acrylics, the prosthesis frame would normally be considered to be an interim provisional frame for an interim provisional restoration prosthesis.

A careful confidential experiment was conducted at New York University of School of Dental Medicine by Dr. C. Jager, Dr. G. R. Goldstein, Dr. E. Hittelman and the Applicant herein. The experiment was designed to compare the performance of a prior art analog of NOBEL BIOCARE®, as shown in FIG. 9, to that of one embodiment of the present invention, as shown in FIG. 4. A statistically significant improvement for the present invention was found in terms of framework fit. Also, resistance to applied torque was found to be significantly improved for the analog of this invention.

The experiment evaluated torque prostheses to laboratory dental implant analogs. The study evaluated the movement of the prior art analog of NOBEL BIOCARE®, as shown in FIG. 9, and the embodiment shown in FIG. 4 of the present invention. Both were torqued to 20 Ncm in a reinforced type IV die stone. 80 analogs were divided into groups of 4 analogs, including three of the prior art analog shown in FIG. 9 with one of the present invention shown in FIG. 4. These analogs were embedded in thirty equal blocks of Type IV plaster stone using a prefabricated four unit implant framework. Of the twenty analogs, ten were imbedded in the stone at a depth of four cm and ten were imbedded at a depth of six cm from the implant platform. These groups of ten were then divided into groups of five each, where five of the prior art analogs shown of the present invention in FIG. 9 were torqued to 20 Ncm in each group and five analogs shown in FIG. 4 were torqued to 20 Ncm. The initial framework was used to evaluate the fit of each analog therein. In the 4 mm depth group of the prior art shown in FIG. 9, two of the five samples (40%) did not allow the framework to fit the analog. In the 6 mm depth of the prior art analogs shown in FIG. 9, three of the five samples (60%) did not allow the framework to fit. However, all of the dental analogs shown in FIG. 4 of the present invention fit back to the cast.

As a result, the analogs of the present invention, as shown in FIG. 4, were able to resist movement within a stone cast when torqued, unlike a significant portion of the prior art dental analogs shown in FIG. 9.

Therefore, the dental analogs of the present invention have unexpected, beneficial results not achievable with the dental analogs of the prior art shown in FIG. 9.

Once the dental analogs are used to create a precise dental prosthesis such as an artificial tooth or group of adjacent teeth, the prosthesis receives a strong internal or side-supporting frame. Therefore, the present invention comprises an internal support frame within the dental prosthesis, which gives support to the prosthesis, no matter how many multiple teeth are included in the prosthesis.

The internal support frame is size adjustable to widen its width, and in certain embodiments can bend away from a linear orientation, to form an angled corner for the teeth of the prosthesis.

Made of sturdy metals or metal alloys such as titanium, nickel titanium, stainless steel, chromium cobalt, nitinol, gold and the like, the internal support frame is sized to fit the location and placement of the prosthetic teeth and is imbedded within the composite material such as from acrylics or resins, which constitute the artificial gum portion and artificial teeth. The support frames can be further strengthened by injection of composite material through a hole in the frame to fill the interior space of the hollow support frame.

To join the support to an implant frame, the base of the internal support frame contains a concentric lip to fit into the dental abutment engagable with a dental implant within the jaw, or to fit directly to the upward protruding end of the dental implant.

The internal support frame is a collection of engagable members which form either a generally H-shaped telescopic configuration when joined together, or two generally L-shaped members which interleave with each other. While the members can be hollow, for adjustable positional movement therein, in another embodiment the members can be semi-cylindrical gutter-type troughs holding another member therein. In either case, the frames are adjustably sized before they are fixed in place by the composite material surrounding the frames.

Holes are provided within the vertical posts of the internal support frame for joining the frame in positional register to the implant by fasteners, such as implant screws.

For the widenable H shaped embodiment, one of the horizontal members is hollow, accommodating the engagable horizontal member of an adjacent vertical post in a telescopic relationship.

For the pair of interleaved L-shaped support frame members, each horizontal wing portion of each L-shaped support frames member has a respective hole in positional register with the other hole and is joined by a hinge post extending vertically within the two hollow wing members. In that way, the angle of orientation can be adjusted as the hinge thus forms swings about a radius to a desired position of orientation above the implants in the jaw.

The internal supports, can be configured also for three or more teeth, either in a linear horizontal arrangement, an angled corner arrangement, or in combination thereof.

Moreover, once the prosthesis is fabricated before it is installed within the mouth of the patient, it's abutment member or members may need period cleaning by abrasive polishing. However abrasive polishing of the abutment can damage the implant abutment joint where the abutment of the prosthesis joins the implant. Therefore, the present invention also includes a protective cap with a concave interior to cover and protect the sensitive protruding abutment joint.

As a result, the present invention provides a system for precise location and installation of dental implants with prostheses within the jaw and the juxtapositioning of a prosthesis upon the implant, both for immediate interim post surgery installation or with respect to permanent installation of prosthesis in the mouth of the dental patient.

### BRIEF DESCRIPTION OF THE DRAWINGS

The present invention can best be understood in connection with the accompanying drawings, in which:

FIG. 1 is a view of a dental lab replica showing the position of an analog and an abutment;

FIG. 2 is a view of a lower jaw about to receive a prosthesis and having two implants;

FIGS. 2A, 2B and 2C are perspective views of transparent guides used in precisely locating an implant within the jaw of a patient;

FIG. 3 is a view of an embodiment of the present invention incorporating a conical abutment;

FIG. 3A is a partial view taken within the phantom circle of FIG. 3, shown rotated ninety degrees for clarity;

FIG. 4 is a view of an embodiment of the present invention incorporating a standard abutment;

FIG. 5 is a view of an embodiment of the present invention corresponding to an implant with a hexagonal protrusion;

FIG. 6 is a view of an embodiment of the present invention corresponding to a large diameter implant with a hexagonal recess;

FIG. 7 is a side elevation view in partial cross section of an embodiment of the present invention corresponding to an implant with a hexagonal recess;

FIG. 7A is a top plan view thereof;

FIG. 8 shows a conventional impression coping with depth indications from 2-5 mm;

FIG. 9 shows a conventional prior art fixture replica, or analog, which is replaced by analog according to the present invention;

FIG. 10 shows the placement of a fixture replica, either a conventional or according to the present invention, in the lab replica that is to be secured to an abutment and a crown via a guide pin;

FIG. 11 shows the attachment of an analog to an impression coping that is fixed in an impression of the relevant section of a patient's mouth prior to the casting of the lab replica;

FIG. 12 shows a dental impression tray modified to provide access to the impression coping that is secured to the implant in a patient's mouth by a guide pin;

FIG. 13 shows the excess material around the impression coping in a tray containing impression material, the impression coping being secured to the implant in the patient's mouth by a guide pin;

FIG. 14 shows a means of securing the impression coping to the tray containing the impression material with an acrylic resin;

FIG. 15 shows the impression containing the impression coping;

FIG. 16 is a top view of an engagement plate of this invention which is used to provide improved anchorage for a conventional analog;

FIG. 17 is an exploded side view of the engagement plate of FIG. 16 attached to a conventional analog;

FIG. 18 is a perspective view of an analog body with a transverse tube configured to screw into a variety of abutments;

FIG. 19 is a perspective view of an analog body with transverse wings;

FIG. 20 is a bottom view of an analog body with transverse wings;

FIG. 21 is a perspective view of an analog body with coplanar transverse tubes at right angles;

FIG. 22 is a perspective view of an analog body with non-coplanar oblique tubes;

FIG. 23 is a bottom view of an analog body with eight co-planar transverse tube segments;

FIG. 24 is a perspective view of an analog body with angled spikes;

FIG. 25 is a side elevation of an analog body with serrated side extensions;

FIG. 26 is a side elevation of an analog body with four serrated and perforated side extensions;

FIG. 27 is a perspective view of an analog body with looped side extensions;

FIG. 28 is a top view of an impression tray of the present invention;

FIG. 29 is a top view exploded in a split configuration of the tray as in FIG. 28;

FIG. 30 is front view thereof showing punchouts;

FIG. 31 is a left side elevation view of the tray showing punchouts;

FIG. 32 is a top view showing the joint split embodiment with fasteners;

FIG. 32A is an enlarged close up diagram of knockouts in the tray;

FIG. 33 is a top view of the tray with impression material, teeth and impression copings therein;

FIG. 34 is a detail side view in cross section thereof;

FIGS. 35 and 36 are exploded views of a support articulated plate wafer connecting opposing impressions within the mouth active as a combined jaw relation jig;

FIG. 37 is a view of a jaw showing a plurality of implants imbedded therein;

FIG. 38 is an exploded perspective view of a lower jaw about to receive two prostheses into four implants;

FIG. 39 is a top plan view of an embodiment of the present invention incorporating a horizontal H-shape;

FIG. 40 is a top plan view of an embodiment of the present invention incorporating a pair of interleaved L-shapes;

FIG. 41 is an enlarged close-up view of an implant engaging a portion of an internal support frame joined to a composite prosthesis;

FIG. 42 is an exploded side elevational view of a pair of L-shaped members forming an internal support frame joining an implant to a dental prosthesis.

FIG. 43 is an exploded top plan view of a widenable H-shaped internal support frame joining an implant to a dental prosthesis;

FIG. 44 is a side view of an H-shaped internal support frame;

FIG. 44A is a bottom view thereof, showing the joint for joining to an implant;

FIG. 45 is a side view of a pair of interleaved L-shaped internal support frame members;

FIG. 45A is a bottom view thereof, showing the joint for joining to an implant;

FIG. 46 is an exploded side elevational view of a trough embodiment;

FIG. 46A is a side elevational view of the trough embodiment joined together;

FIG. 47 is a side view of a three interleaved L-shaped internal support frame members;

FIG. 47A is a bottom view thereof, showing the joint for joining to an implant;

FIG. 48 is a side view of an H-shaped internal support frame with multiple subframe members;

FIG. 48A is a bottom view thereof, showing the joint for joining to an implant;

FIG. 48B is a side elevational view of a further embodiment for a prosthesis support frame with both linear and swivelable adjustability;

FIG. 48C is a bottom view thereof;

FIG. 49 is an exploded side elevational view of a trough embodiment with multiple subframe members;

FIG. 49A is a side elevational view of thereof, shown joined together;

FIGS. 50 and 51 are top views of alternate connector portions of adjustable support frames for dental prosthesis;

FIG. 52 shows a hollow support frame being filled with composite material through a hole in the hollow support frame;

FIG. 53 is a side perspective view of a prior art abutment above and implant;

FIGS. 54 and 55 are exploded views of modified straight or angled abutments;

FIG. 56 is a side view of a double ended screw used with the modified abutments of FIGS. 54 and 55;

FIG. 57 is a perspective view of the moldable lingual frame for a provisional post surgery prosthesis and;

FIGS. 58 and 59 show a protective cap for protecting the abutment joining portion of a tooth to be polished.

### DETAILED DESCRIPTION OF THE INVENTION

Simplified, the construction of the prosthesis begins after the osseointegration of the implant with the dentist making an impression of the relevant section of the patient's mouth. When constructing the prosthesis, the dentist makes an impression including an impression coping. Desirably, the impression material employed is hard and elastic when set, such as the materials sold under the trade names Impragum, Express and President.

Once the impression material hardens, the tray containing the impression is sent to a dental lab where the prosthesis is made. The dental lab uses this impression to make a replica of the relevant section of the patient's mouth. Typically, the replica is made of gypsum, and is made to reproduce the milieu into which the prosthesis is to fit, including, for example, any hexagonal protrusion or recession in the abutment the dentist is using.

For example, FIG. 1 shows a view of dental lab replica 130 with analog 120 and abutment 110.

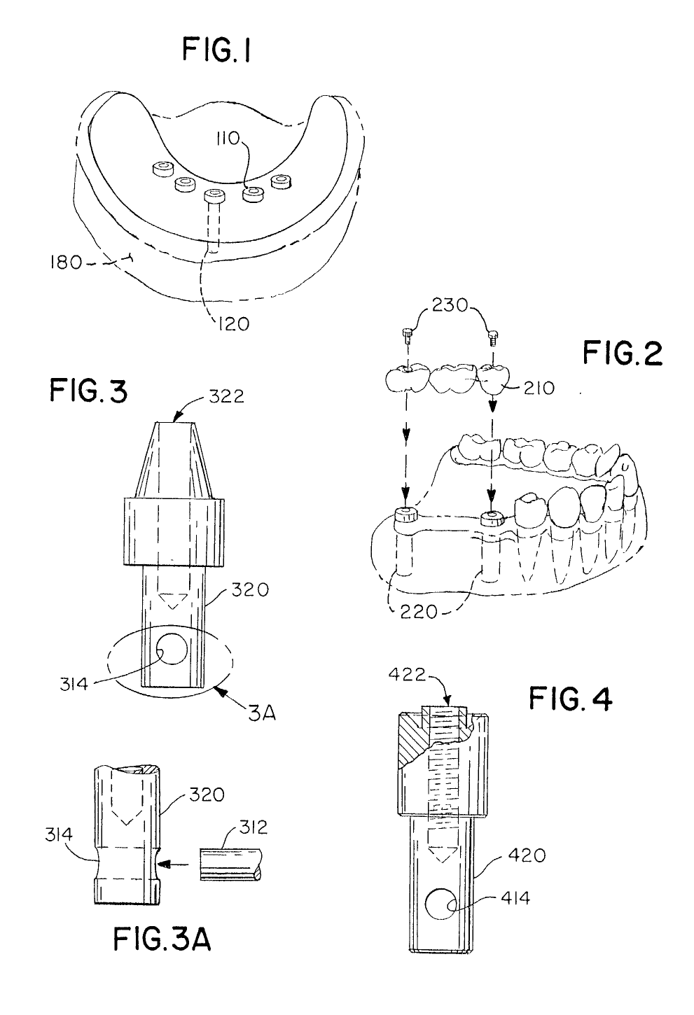

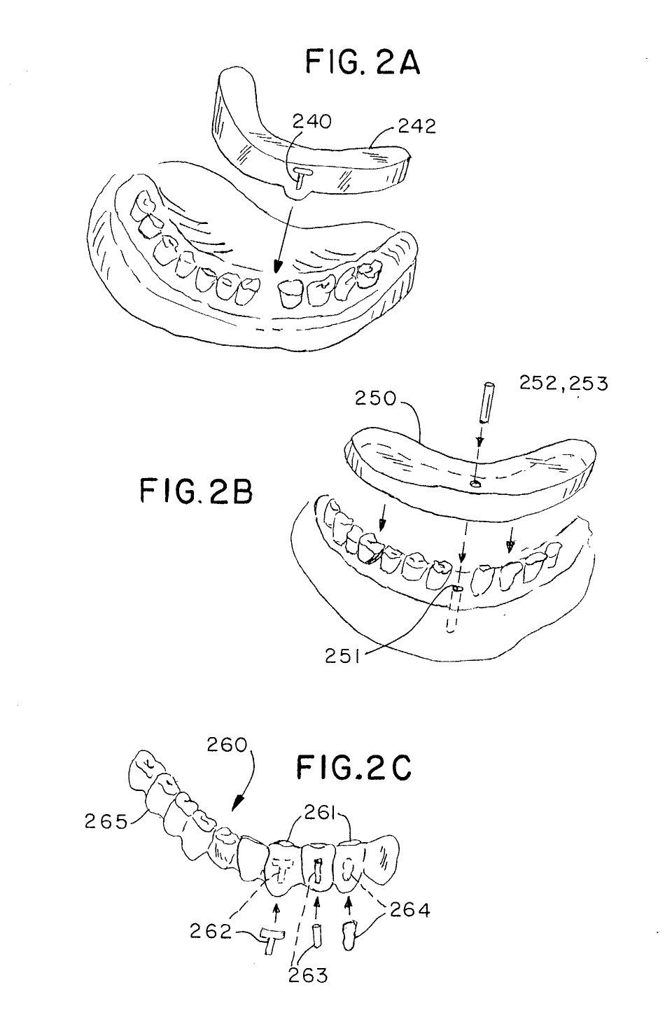

Moreover, FIG. 2 shows an actual patient lower jaw with two implants 220, a three tooth prosthesis 210 and screws 230 to retain prosthesis 210 in implants 220.

As shown in FIGS. 2, 2A, 2B and 2C, before the impression for the artificial tooth or teeth is made for a prosthesis, the actual implant must be precisely located in the jaw of the patient. To accomplish this, the present invention uses a conventional guide showing of the transparent guide 240 or stent showing the position of the future implant 241 for replacement tooth, in comparison with the location of existing teeth and/or gums and jawbones.

In FIG. 2A, transparent guide 240 includes radio-opaque material 242, such as barium sulfate, to mark the point where the implant is to be precisely inserted into patient's jaw.

As shown in FIG. 2B the present invention therein modifies the conventional transparent guide 250 by inserting an alignment drilling tube or cylindrical sleeve 252 or for precisely drilling the site 251 for the implant by drill 253. This same tube or cylindrical sleeve 252 can be taken out of the guide and subsequently used for taking an impression for holding an interim post-surgical prosthesis, or for placement of an abutment in a final positioning of a prosthesis.

Analog 120 can then be attached to the tube or sleeve 252 for pouring the master cast, as shown in FIG. 1. The cylindrical sleeve is preferably made of titanium, nickel titanium, nitinol, ceramic or composite plastic materials.

FIG. 2C shows shows transparent guide 260 with radio-opaque teeth portion 261 having internal portions 262, 263, 264 adjacent to transparent teeth portion 265.

FIG. 2C also shows radio opaque markers 262, 263, 264 placed internal (for scanning) for each tooth or teeth of this interim restoration or the final restoration.

The tooth or teeth are placed in an indexing jig or stent jig with an occlusal vertical and horizontal guide plate. The adjustable frames and the new abutments are retrofitted and processed in to the restoration. The stent and indexing jib are removed from the restoration. The patient then has the benefit of having teeth placed on the implants when immediately leaving the doctor's office after implant surgery.

In making the impression, the impression coping is attached to the implant in the same way the final prosthesis will attach. The impression coping rests flush on top of the implant, or implant and abutment, with a guide screw passing through and into the implant. The impression coping remains in the impression in the same position that was in the mouth and the guide screw must be removed before the impression can be removed from the patient's mouth.

In making the dental lab jaw model, or replica, the analog is attached to the impression coping with a guide screw going through the impression coping and into the analog. All of the teeth in the relevant portion of the mouth are replicated in the model, which desirably is made of gypsum. The goal is to have the analog in the replica in the position that corresponds to the position of the implant in the patient's mouth, including the orientation of any protrusion or recess.

The present day tools offered by the implant manufacturers utilize brass or stainless steel analog.

The configuration of the prior art analogs replicates the internal thread dimension of the implant or abutment and copies the shape of the external or internal hexagon. However, the outside diameter of a prior art analog maintains a shape that is not consistent with the needs of the dentist or technician in constructing the prosthesis. Conventional analogs are too small and are removed from the gypsum model too easily. Moreover, the exterior surface of conventional analogs are too smooth which permits the analog, and thus the prosthesis, to rotate in the model during construction of the prosthesis. Such rotation moves the hexagonal position of the prosthesis into a position that does not match the corresponding position of the implant in the patient's mouth.

In contrast to the prior art conventional, easily rotatable and dislodgable dental analogs, the present invention is a new analog that will not allow any rotation in the gypsum model. In a preferred embodiment, as shown in FIGS. 3 and 3A, the analog 320 of the present invention is substantially longer and has a unique feature of a transverse pin 312 or other protruding geometric shaped member extending through hole 314 in its side.

FIG. 4 shows analog 420 with abutment 22 and hole 414 for insertion of a pin therein, similar to pin 312 of FIG. 3A.

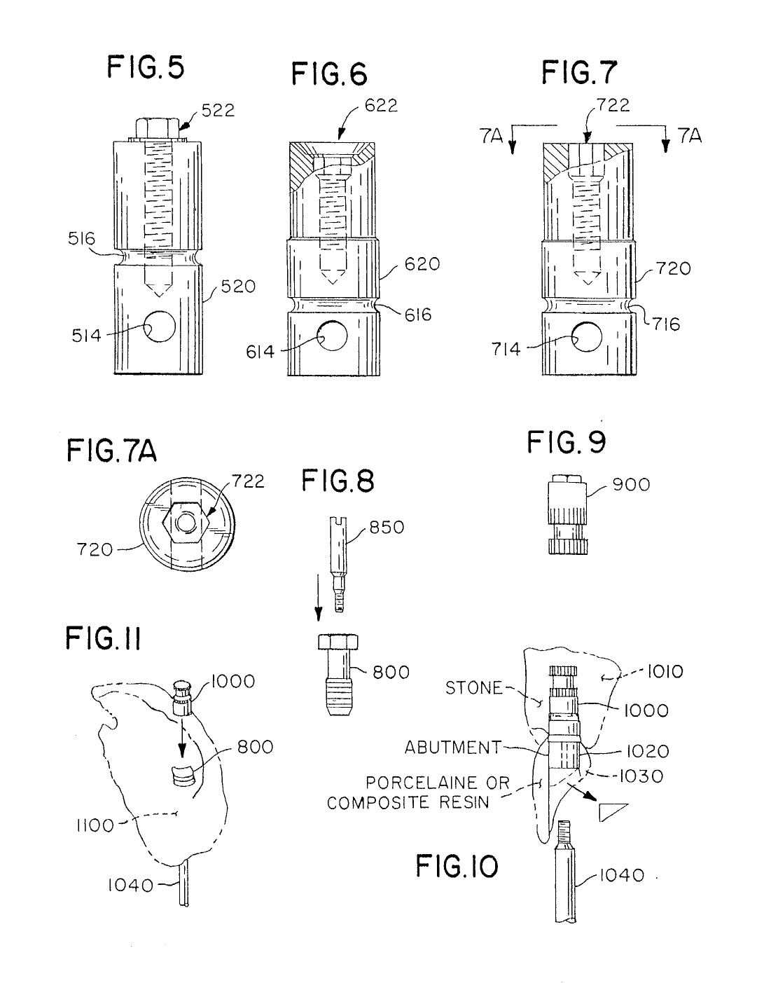

As shown in FIGS. 5, 6, and 7, these dental analogs 520, 620 and 720 of the present invention are preferably ridged with annular recesses, these dental analogs 520, 620 and 720 on their respective sides to gain better retention inside the gypsum model.

Analogs 420, 520, 620 and 720 have respective pins (not shown) similar to transverse pin 312 of analog 320 of FIG. 3A. These pins 312 are located at the base of the respective analogs 320,420, 520, 620 and 720 to lock the position. These transverse pins 312 prevent horizontal, vertical or cylindrical movement of the analogs 320, 420, 520, 620, and 720 within the model.

Conventional implants have a standardized system of heights, measurements and dimension for implants and abutments. The respective inventive analogs 320, 420, 520, 620, 720 of the present invention can have a shape which incorporates a conical abutment 322 (FIGS. 3 and 3A), a standard abutment 422 (FIG. 4), a hexagonal protrusion 522 (FIG. 5), a large hexagonal recess 622 (FIG. 6) or a hexagonal recess 722 (FIG. 7), as these terms are used in the dental industry.

Analogs 520, 620 and 720 also bear annular grooves 516, 616 and 716.

The analogs 320, 420, 520, 620 and 720 of the present invention are machined to specified mechanical tolerances. In particular, the internal thread of the inventive analogs are closer to the threads of actual implants and abutment. This closer approximation to the actual implants insures that the guide screw goes into the implant the same number of turns the guide screw goes into the analog, and maintains the prosthesis in the same position relative to the patient's mouth as the prosthesis had with respect to the replica. The internal or external hexagon is also closer in dimensions to the actual implant. As a result, the prosthesis will fit on the analog and on the actual implant or abutment in the manner intended.

Another complication in the construction of dental analogs is that it is often necessary to construct a large frame using soldered connections. Also, shaping, cutting or grinding of the abutment on the analog can loosen the analog in the cast. The present methods of soldering require a duplicate model of high heat tolerance gypsum investment be made with the present day analogs. The frame is soldered on that model. The success rate of these solder connections is far lower than expected in the industry. The present invention allows a more accurate solder connection. The present invention also holds better in the invested model and keeps the analogs from moving in the model.

### EXAMPLE

In the single tooth prosthetic work, the impression is taken from the fixture level. As shown in FIG. 8, one type of conventional impression coping 800 has an internal hexagon at the base, which corresponds to the hexagon of the abutment. The coping has depth indications for assessment of proper abutment size, 2 mm, 3 mm, 4 mm, and 5 mm. The upper margin of the abutment-like part indicates 6 mm. The impression coping is typically made of titanium.

The impression coping is used together with a special guide pin (e.g., a DCA 098), 850, for a single tooth (the guide pin used to secure the prosthesis to the implant typically has a different thread).

Typically, in the laboratory, any undercuts of the impression coping are blocked out before pouring the impression (including the depth indications). This blocking is especially important when the longest abutment is used. This precaution prevents fracturing the cast when separating the model and the impression coping.

During the Laboratory procedure, an analog, for example a conventional prior art analog 900 shown in FIG. 9, or an analog of the present invention such as the analogs of FIGS. 3-7, is used in the laboratory jaw model, or replica, to represent the implant in the working cast. This is illustrated in FIG. 10 where analog 1000 is set in the laboratory jaw model, or replica, 1010, and the abutment 1020 and crown 1030 are secured to the jaw model by guide pin 1040. The analog has the same top hexagon and internal thread as the implant. In contrast to the stainless steel analogs of the present invention, conventionally, analogs were typically made of nickel-plated brass.

FIG. 11 shows an impression 1100 containing an impression coping 800 being attached to an analog 1000 via guide pin 1040. Once the analog 1000 is secured to the impression coping 800 by the guide pin 1040, the impression 1100 is used to cast the laboratory jaw model, or replica, from stone, such as gypsum.

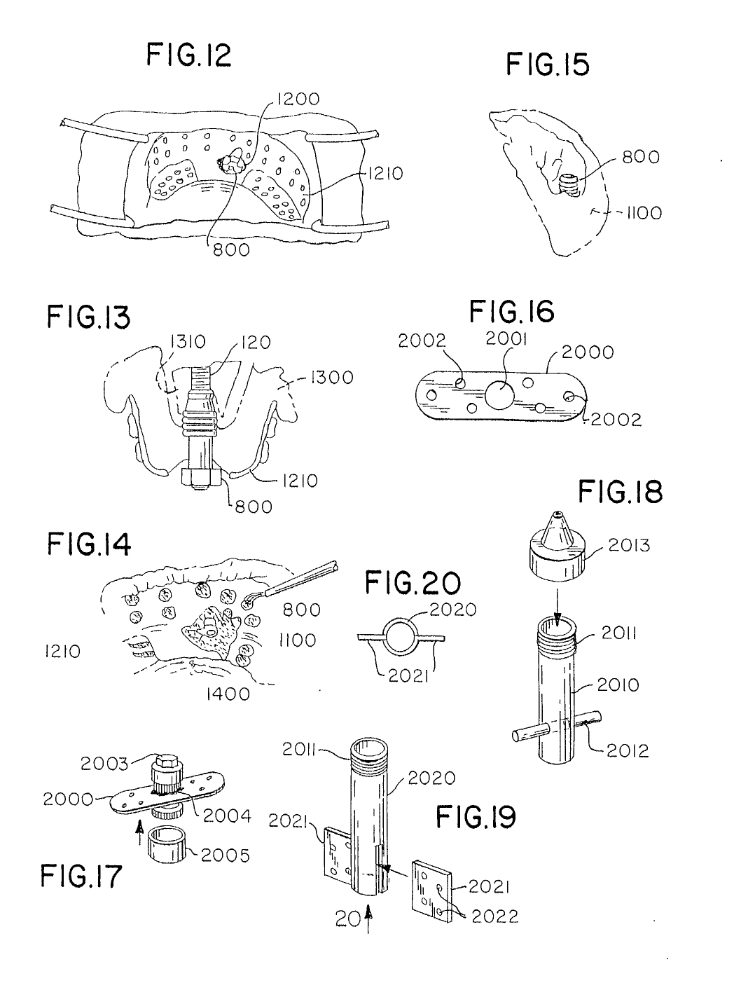

The impression 1100 containing the impression coping 800 can be prepared in any conventional manner. For example, as shown in FIG. 12, one can make a hole 1200 in an acrylic-resin stock tray 1210 for access to the impression coping 800 which is secured to the implant by the guide screw.

FIG. 13 shows tray 1210 loaded with an impression material of choice 1300 in the mouth with impression coping 800 secured to implant 120 within the patient's jaw 1310.

FIG. 13 also shows the removal of any excess material around impression coping 800 once impression material 1300 has set.

Impression coping 800 is then secured to tray 1210 with auto-polymerizing acrylic resin 1400. The orientation of the hexagonal head of the implant 120 should be maintained when the impression 1100 is removed. Next, guide pin 850 is unscrewed and impression 1100 is carefully removed form the patient's mouth.

As noted before, FIGS. 3-7 show different embodiments of the dental analogs 320, 420, 520, 620 and 720 of the present invention each using a transverse rod pin 312 or tube within hole 314, 414, 514, 614, or 714, in the base section of each analog 320, 420, 520, 620, or 720 to enhance the anchoring of the analog in the plaster of the replica. Each of the different embodiments uses a different style of abutment 322, 422, 522, 622, or 722 to match that which the dentist had used in the patient's actual implant.

For example, FIG. 3 shows a conical abutment 322 for analog rod 320 and FIG. 4 shows a standard recessed abutment 422 for analog rod 420. FIG. 5 shows an abutment 522 with a hexagonal protrusion for analog rod 520, FIG. 6 shows a large diameter abutment 622 with a hexagonal recess, for analog rod 620, and FIG. 7 shows an abutment 722 with a hexagonal recess for analog rod 720.

FIG. 16 shows another embodiment of this invention in the form of a flat engagement plate 2000 which is used to provide enhanced anchoring of a standard prior art analog 900 (see FIG. 9) in the replica plaster.

As shown in FIG. 17, the conventional analog 2003 is inserted through central hole 2001 and adhesively bonded 2004 at an oblique angle. Perforations 2002 enhance adhesion to immobilize plate 2000 in replica plaster. An optional hollow sleeve 2005 can be used to extend the vertical height of analog 2003, to further promote its anchoring within the replica plaster.

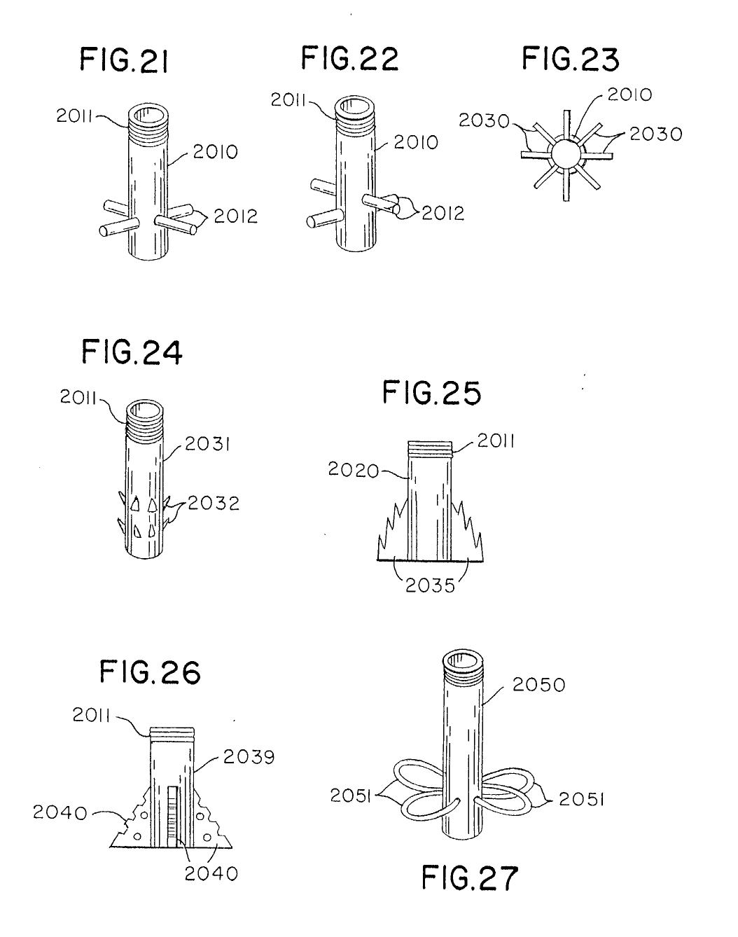

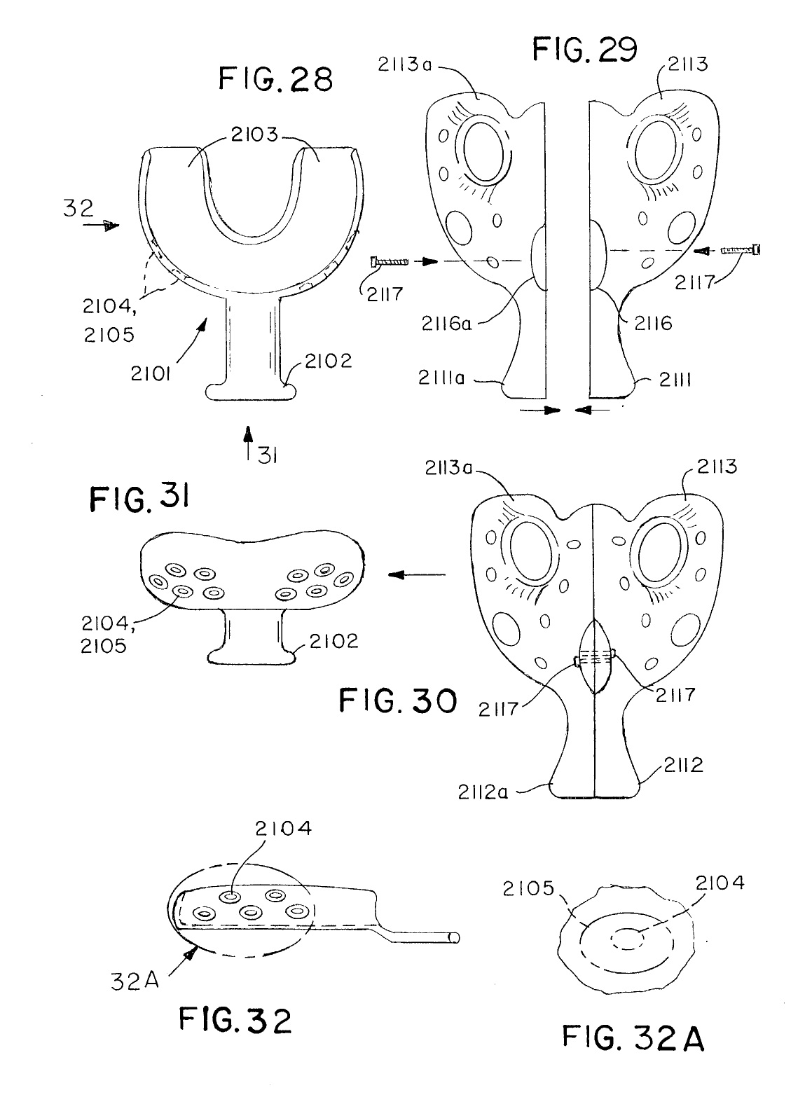

It is further noted that optional removable hollow sleeve 2005 can also have any of the protrusions shown in the other drawing figures, such as protrusion rods 2012 of FIG. 18 or FIG. 21, protrusion 2022 of FIG. 19, protrusion wings 2030 of FIG. 23, protrusion barbs 2032, protrusion wings 2035 of FIG. 25, protrusion wings 2040 of FIG. 26 or protruding loops 2051 of FIG. 27.

FIG. 18 shows the concept for a series of additional embodiments of analogs of this invention which use a tubular body 2010 with external threads 2011 at the top end. These threads screw into mating female threads on a series of abutments 2013 (here illustrated as a conical abutment) which are supplied to match the style and size actually implanted in the patient's jaw.

Therefore, analogs of this general category of embodiments can be matched with a variety of abutments 322, 422, 522, 622, or 722(as described in FIGS. 3-7). The analog 2010 with conical abutment 2013 of FIG. 18, similar to analog 320 with a conical abutment 322, uses a transverse tube or rod 2012 to aid in anchoring body 2010 in plaster. Slotted body 2020 as shown in FIG. 19 accepts two rectangular wings 2021 (as shown in bottom view of FIG. 20) with perforations 2022 as yet another embodiment to resist rotation within, and extraction from, the replica plaster.

The embodiment shown in FIG. 21 uses coplanar radial transverse tubes 2012 at right angles to each other to provide anchorage.

The embodiment shown in FIG. 22 uses two oblique tubes 2012 which penetrate body 2010 as anchorage.

The bottom view of the embodiment of FIG. 23 shows eight equally spaced tubular segments 2030 attached to body 2010 to provide anchorage in replica plaster.

FIG. 24 shows an embodiment of an analog using tubular body 2031 with upward angled spikes 2032 in two rows to provide anchorage.

The embodiment of FIG. 25 shows slotted body 2020 with a pair of serrated triangular wings 2035 to provide anchorage in the replica plaster.

FIG. 26 shows an embodiment of an analog with body 2039 with four slots accommodating four perforated and serrated triangular wings 2040 to rigidly anchor it to the plaster of a replica.

Furthermore, FIG. 27 shows an embodiment of an analog using tubular body 2050 with one or more outwardly extending looped extensions 2051 to promote anchorage.

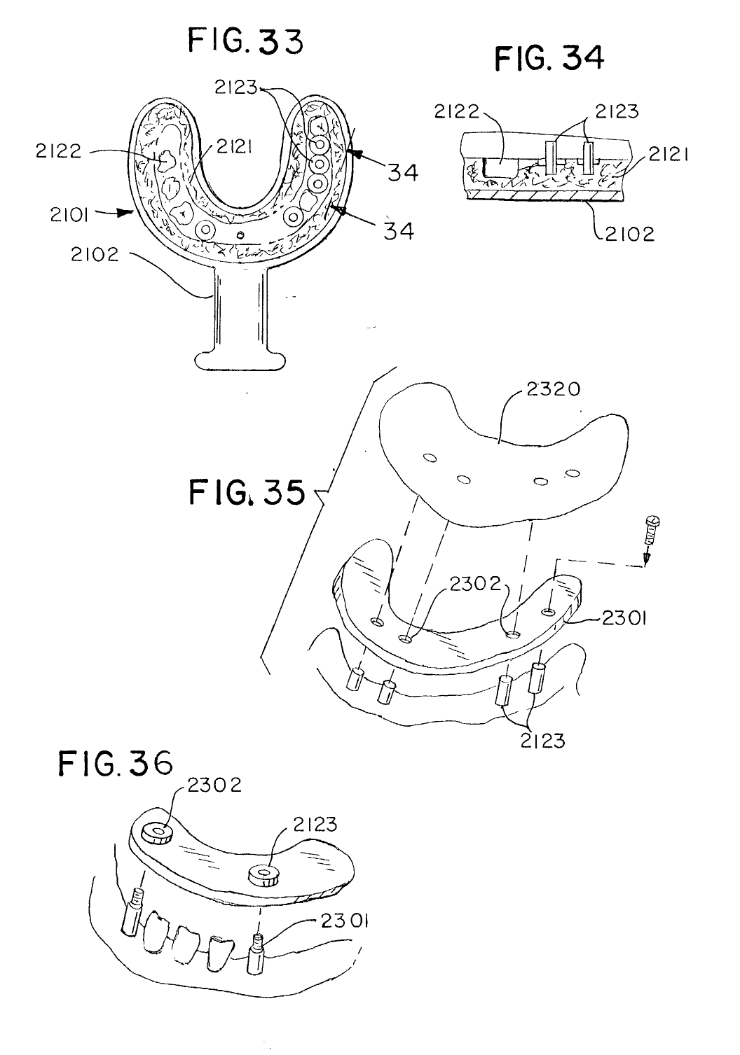

FIGS. 28-36 show improved impression trays, for holding impression mold material for the patient to bite into and leave a mirror image of the patient's bite therein.

FIGS. 28, 31, 32, and 32A, 33, 34 shows tray 2101 having handle 2102 and left and right hollowed out wings. Impression tray 2101 includes one or more punchouts 2104, 2105 similar to punch outs in electrical boxes, so that holes can be appropriately made to allow for the spacing and protrusion of implant impression copings protruding upward from the implants.

In a typical configuration, a continuous or interrupted seam is provided around the exterior configuration of the punchout. The seam is broken by a force which is less then the strength of the tray wall therein, so that punching out the punchout leaves a hole in the tray wall, while leaving the rest of the tray wall intact.

The punchouts, also known as knockouts, include one or more smaller knockouts 2104 which can be punched through to provide a hole to accommodate a protruding impression coping therethrough. The smaller knockouts 2104 have a similar seam as that of a larger knockout 2105 in which smaller knockouts 2104 are located. However, smaller knockouts 2105 can be broken by a force which is less that the force necessary to punchout larger knockout 2105, leaving a hole in larger knockout 2105, while larger knockout 2105 remains intact. If a larger area is needed than is produced by removing knockout 2104, larger knockouts 2105 can be punched out for a larger hole.

To make it easier to remove a tray from the mouth, FIGS. 29 and 30 show split tray 2111 having handle 2112 and opposing handle 2112A.

Respective left and right half portions 2113 and 2113A of split tray 2111 are joined through a joining mound of two bulging half portions 2116, 2116A, which are joined by one or more screw fasteners 2117 therethrough. Split tray 2111 can also be provided without knockouts 2104 and 2105 if used for dental procedures not involving implants with protruding impression copings protruding through tray 2111.

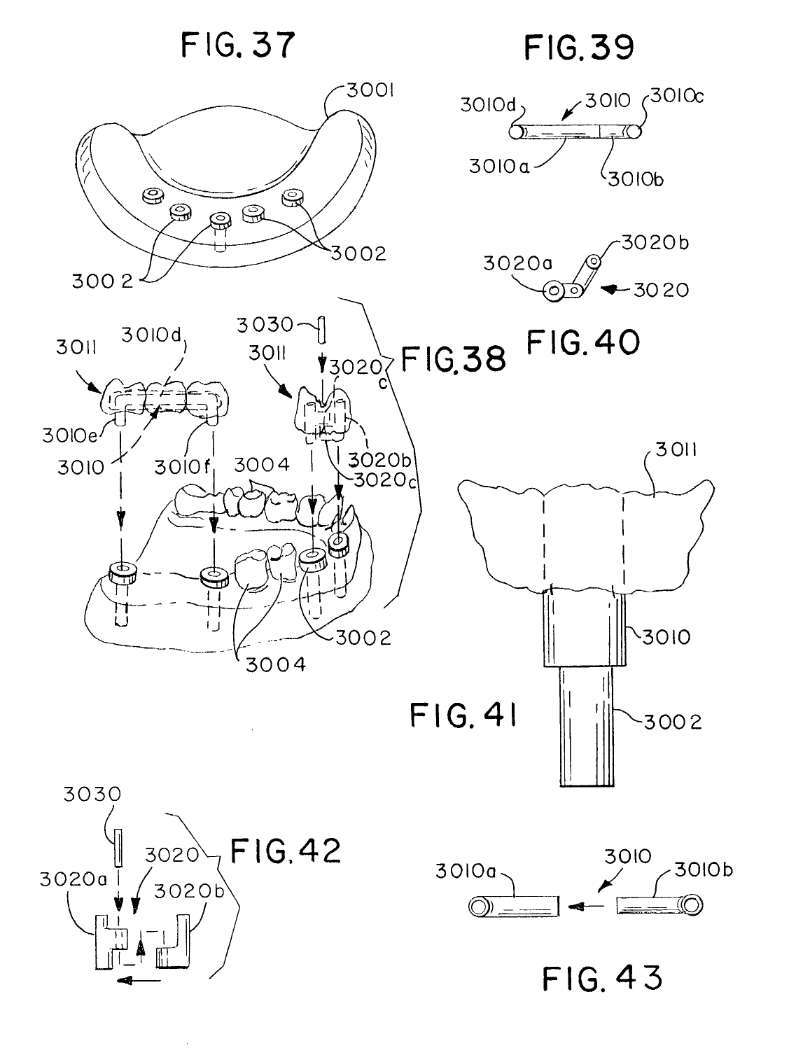

A further improvement includes a solid acrylic perforated wafer support substrate 2301, as shown in FIGS. 35 and 36, which is a jig for articulator plates with wax rims to support a wax impression for the opposite jaw above a prosthesis cast from the opposing jaw arch.

For example, wafer 2301 includes holes 2302, to accommodate protruding impression copings 2123 therethrough. Wafer substrate 2301 can be strongly held temporarily in place by screwing impression coping 2123 to permanently affixed implant 220 in the patient's jaw.

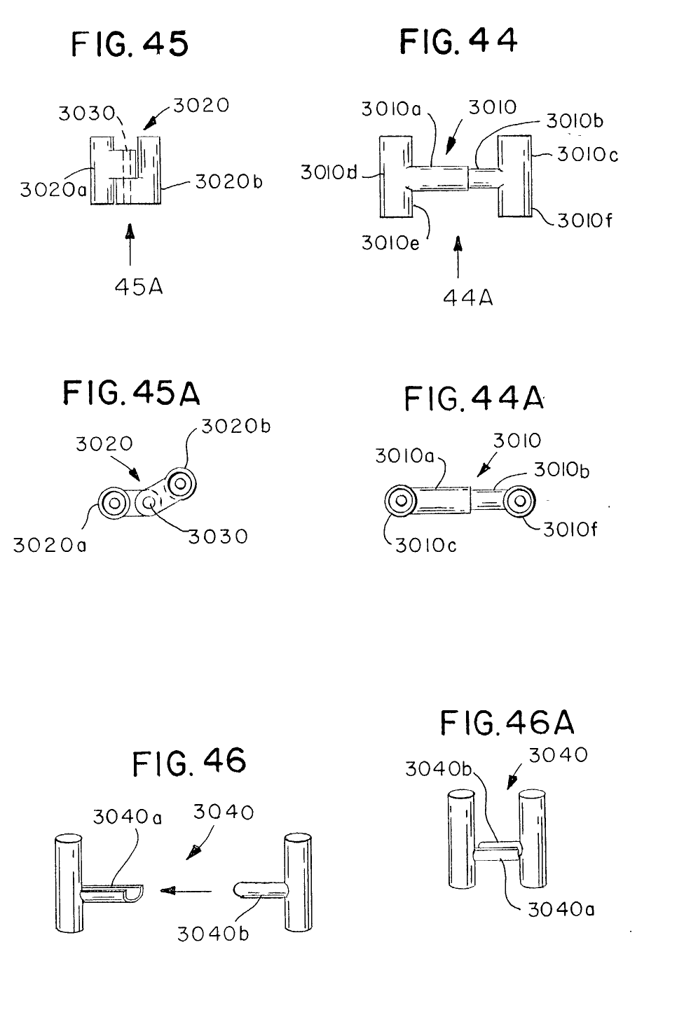

FIGS. 37-52 show novel internal and external support frames for strengthening a dental prosthesis with artificial teeth above one or more implants.

For example, FIG. 37 shows jaw 3001 having implants 3002 in general. However, FIG. 38 shows jaw 3001 having implants 3002 receiving linearly extending H-shaped support frame member 3010 having horizontal telescopic sections 3010a and 3010b, as well as upward vertical posts 10d and 10c and lower vertical posts 3010e and 3010f. The internal support frame 3010 is imbedded within artificial composite dental prosthesis 3011 simulating teeth.

FIG. 38 also shows an internal support frame formed by a pair of interleaved L-shaped members 3020a and 3020b having horizontal wings 3020c and 3020d joined by hinge rod 3030 to form a swivelable hinge that can form angular corners.

FIGS. 39-45A shows the various parts of the two embodiments, which can be expanded to hold three or more artificial teeth as well.

FIGS. 46 and 46A show a further alternate embodiment for support frame 3040 where a member 3040a is a semi-cylindrical gutter-type trough holding another member 3040b therein.

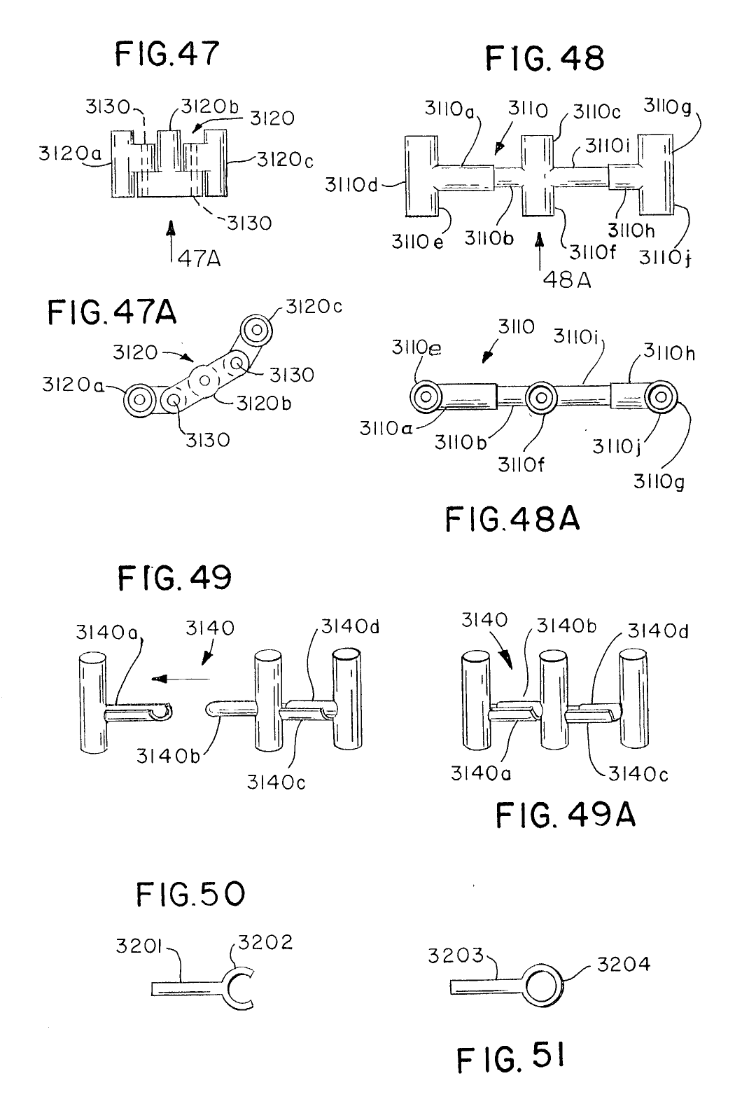

FIGS. 47, 47A, 48, 48A, 48B, 48C, 49 and 49A show respective internal support frames 3110, 3120 and 3140 configured for three or more teeth, either in a linear horizontal arrangement, an angled corner arrangement, or in combination thereof.

In FIGS. 47 and 47A, adjustable internal support frame 3120 includes posts 3120a, 3120b and 3120c joined by rods 3130 in both angled and linear orientations.

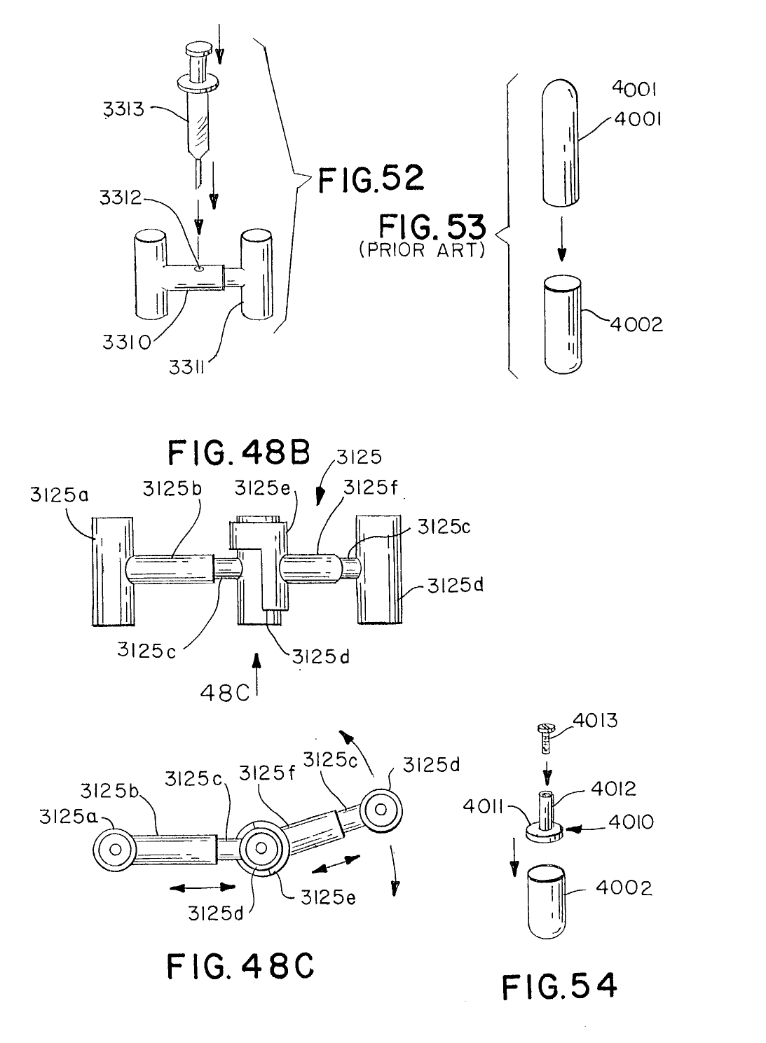

In FIGS. 48 and 48A, adjustable internal support frame 3110 includes horizontal member 3110a holding horizontal member 3120b in a telescopic relationship and horizontal member 3110h holding horizontal member 3101I in a telescopic relationship. Three posts made of respective upward and downward extending prong pairs 3110d, 3110e, 3110c, 3110f and 3110g, 3110j are joined together by horizontal members 3110a, 3110b, 3110h and 3110i.

FIG. 48B shows a further embodiment for a prosthesis support frame 3125 with both linear and swivelable adjustability. For example, support frame 3125 includes a linear expansion link made of vertical post 3125a, which includes horizontally extending member 3125b which telescopes with horizontal member 3125c of further vertically extending post 3125d sliding therein. A further linear expansion and swivelable link includes another horizontal member 3125c of further vertical post 3125d telescoping inside of horizontal member 3125f of vertically extending swivel member 3125e. More links can be added to accommodate three or more artificial teeth, which may be positioned in linear and/or angular relationship with each other.

FIGS. 49 and 49A show an alternate embodiment for the trough or gutter version, where internal support frame 3140 includes troughs 3140a and 3140c supporting respective horizontal prongs 3140b and 3140d.

FIG. 50 shows respective open connectable C-shaped clasp 3202 for support frame member 3201. FIG. 51 shows closed loop connector 3204 of support frame member 3203.

In FIG. 52, there is a depicted syringe 3313 for injecting composite material through hole 3312 of support frame member 3310 adjustably connected to reciprocal support frame member 3311.

In all of the above embodiments of FIGS. 37-52, the respective support frames are adjustably sized before they are fixed in place by the composite material, such as a resin or ceramic material surrounding the frames.

As shown in FIGS. 53-56, variations of abutment configurations are provided above an implant. As shown in FIG. 53, currently solid generally cylindrical abutments 4001 are attached above an implant 4002 for attaching a prosthesis above the implant 4002. However, as shown in FIG. 54 abutment 4010 above implant 4002 can be changed to include a small strong platform 4011 with a hollow shank chimney 4012 extending upward for insertion for abutment fastener screw 4013 therethrough.

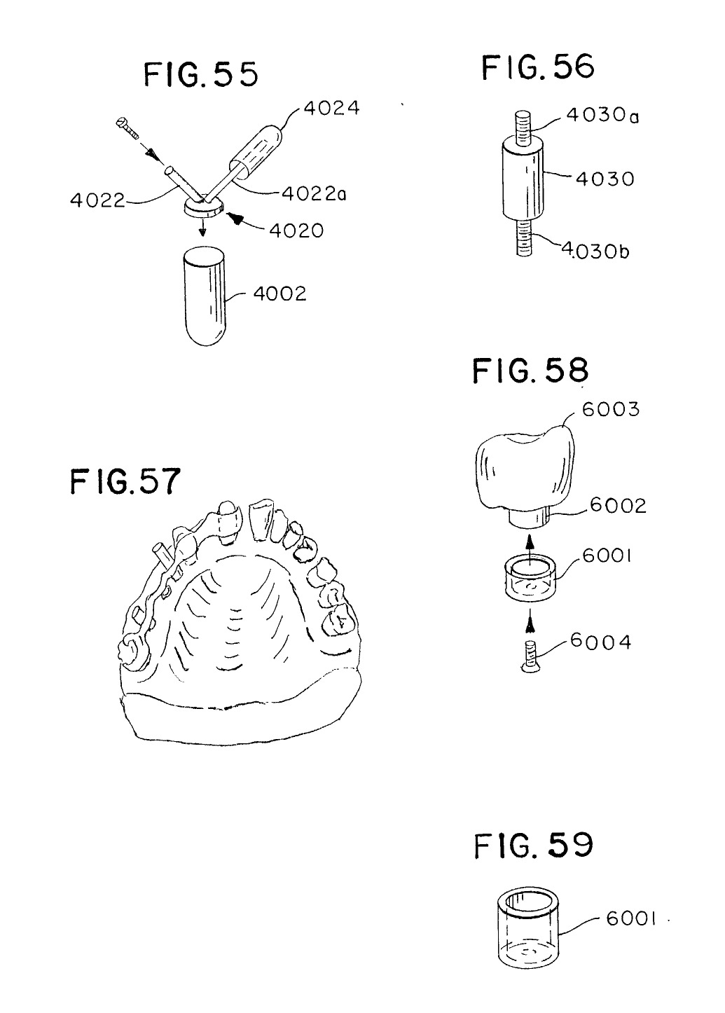

As shown in FIG. 55, modified abutment 4020 can have two posts 4022 and 4022a including post 4022 folding the abutment and another post 4022a oriented for the tooth in case the tooth is at an angle such as near the back of the mouth. To accommodate a tooth above abutment 4010, hollow sleeve 4024 is provided.

Use of modified abutments 4010 and 4020 minimize the use of excess material since the posts 4012, 4022 and/or 4022a are surrounded by strong composite ceramic material anyway, thus minimizing the amount of titanium metal used for the respective abutments 4010 or 4020. A further improvement for a double end connecting screw 4030 having threaded portions 4030a and 4030b is shown in FIG. 56 for connecting abutments to implants. While FIG. 56 shows threaded portions 4030a and 4030b extending outward in opposite directions with the same axis, where a post 4022a extends upward at an angle from the axis above implant 4002, then threaded portions 4030a and 4030b can extend outward in different axes (not shown).

A further improvement shown in FIG. 57 includes an interim frame installed right after surgery. With post surgical swellings one needs to have a bendable frame while the mouth is healing, to give some give and allow for swelling of the tissues during healing. Therefore a provisional interim frame is preferable made with a bendable nitinol metal or plastic fiber composites. In certain circumstances, given the strength of the composite or ceramic material forming the prosthesis, the interim prosthesis may be strong enough to be a final permanent prosthesis. However, if made with acrylics, the prosthesis frame would normally be considered to be an interim provisional frame for an interim provisional restoration prosthesis.

Furthermore, as shown in FIGS. 58 and 59 the present invention includes polishing caps 6001 which are hollow concave members to cover and protect holding edges 6001 of an artificial tooth or prosthesis 6003 when polishing and cleaning work is being done upon the toothlike exterior surface of prosthesis 6001.

In conclusion, the stable dental analog system of the present invention includes the steps of first locating the position of an implant. Then an impression is formed with a moldable material bitten by the patient to leave a mirror image of the patient's mouth with the impression and when the implants are installed, impression copings are put in the mouth above the implant. The next step is filling and impression tray with polyvinyl siloxane or polyether rubber impression material. The next step is putting the tray in the mouth. Then unscrewing of the impression copings from the implant in the jaw occurs. The next step is removing the tray and impression material with the coping imbedded in the impression material, out of the mouth and away from the implant. The next step is to put analog replicas on the copings in the impression cast thus formed, to simulate the position of the actual implant in the position in the jaw at the correct angle and orientation within the casting stone material. The next step is to make the master cast out of plaster or other material. After one impression is made, next step is to do an impression of the opposite side of the mouth with a wax supported over a hard acrylic wafer, which acts as an alignment tool between a lower mouth cast and an upper cast. Both casts have holes for allowing screws to attach the wafer in place. These screws are screwed into the implant in the mouth. The wafer is stabilized in the mouth so the wafer can in turn stabilize the upper wax material. The copings in the wax cast engage the actual implants in the jaw.

The final step is to make the teeth.

It is further know that other modifications may be made to the present invention without departing from the scope of the invention, as noted in the appended claims.

I claim:

1. A dental tray for holding impression mold material for a patient to bite and leave a mirror image of said bite comprising:
a pair of hollowed out right and left wings forming a trough holding said impression mold material therein; and
at least one punchout formed in one of said wings to allow for the spacing and protrusion of at least one implant impression coping protruding upwardly from an implant within the jaw of the patient, said implant having a mating joint joinable to said at least one impression coping.

2. The dental tray as in claim 1 wherein said at least one punchout is a plurality of punchouts formed in said wings to allow for the spacing and protrusion of implant impression copings protruding upwardly from implants in the jaw of the patient.

3. The dental tray as in claim 1 wherein each said punchout comprises at least one further smaller punchout located within the confines of said at least one punchout.

4. The dental tray of claim 1 in which said tray has a handle, said tray and handle being split into a pair of parts joined by at least one fastener.

5. The dental tray as in claim 4 wherein said at least one removable fastener is a plurality of fasteners joining said wings through a pair of protrusions forming a joint therebetween.

6. A dental tray for holding impression mold material for a patient to bite and leave a mirror image of said bite comprising:
a pair of hollowed out right and left wings forming a trough holding said impression mold material therein;
and said tray having a handle, said tray and handle being split into a pair of parts joined by at least one fastener.

7. The dental tray as in claim 6 wherein said at least one removable fastener is a plurality of fasteners joining said wings through a pair of protrusions forming a joint therebetween.

8. A transparent guide for accurately locating the position of a future dental implant comprising:
a transparent replica of existing teeth and gums of a patient, said transparent guide having a radio opaque sleeve tube locating a potential position of an implant into the jaw of a patient; and,
said radio opaque sleeve tube engagable with said implant when said implant is installed into the jaw of the patient.

9. The transparent guide as in claim 8 wherein said radio opaque sleeve tube is used as a structural component of a prosthesis having at least one tooth.

10. A temporary dental frame for a prosthesis made from a bendable material to allow for adjustment as swollen tissue heals after dental surgery.

11. The dental frame of claim 10 in which said frame is made from bendable nitinol metal.

12. The dental frame of claim 10 in which said frame is made from a bendable plastic fiber composite.

13. A support frame for strengthening a dental prosthesis with artificial teeth above one or more implants, comprising:
spaced vertical posts for supporting artificial teeth on dental implants; and
means connecting said vertical posts by adjustable
members allowing for adjustments in spacing between said vertical posts.

14. The support frame as in claim 13 wherein said adjustments are adjustments in linear spacing between said posts.

15. The support frame as in claim 13 wherein said adjustments are adjustments in angular orientation between said vertical posts.

16. The support frame as in claim 13 wherein said adjustments are adjustments in linear spacing and in angular orientation between said vertical posts.

17. The support frame of claim 13 in which said connecting means have telescoping sections joining said vertical posts.

18. The support frame of claim 13 in which said connecting means are formed from interleaved L-shaped members.

19. The support frame of claim 13 in which said connecting means include a hinge to form angular corners.

20. The support frame of claim 13 in which said connecting means is adaptable for joining three or more vertical posts, each of said vertical posts supporting one artificial tooth.

21. The support frame of claim 13 in which said connecting means includes semi-cylindrical gutter-type trough members joining said vertical posts.

22. The support frame of claim 21 in which three or more teeth are joined by said trough members.

23. The support frame of claim 13 in which said connecting means includes a C-shaped clasp connector.

24. The support frame of claim 13 in which said connecting means includes a closed loop connector.

25. The support frame of claim 13 in which said adjustable members have openings to permit the injection of a composite resin fix said support frame any adjusted position.

26. A dental tray for holding impression mold material for a patient to bite and leave a mirror image of said bite comprising:
a layer of said impression mold material for obtaining a lower jaw impression;
a wafer for obtaining an upper jaw impression; said wafer being a perforated substrate for supporting impression mold material thereon,
said perforated substrate being a jig for articulator plates with wax rims to obtain an upper jaw impression above a lower jaw impression.

27. The dental tray of claim 26 in which said wafer includes holes to accommodate protruding impression copings therethrough.

28. The method of implanting artificial teeth comprising the steps of:
locating the position of an implant;
taking an impression using a moldable material bitten by a patient to obtain a mirror image of a portion of a patient's jaw in which said implant will be located by inserting in the mouth an impression tray containing an impression material with copings;
after biting,removing said tray with the coping imbedded in the impression material;
producing an impression cast from said impression material;
placing analog replicas on the copings in the impression cast to simulate the position of the actual implant in the position in the jaw at the correct angle and orientation;
producing a master cast from the impression cast;
making an impression of an opposite side of the jaw with impression material supported over a hard wafer substrate acting as an alignment tool between a lower mouth cast and an upper cast, both casts having holes for allowing screws to attach said wafer in place; and
making the artificial teeth.

29. A dental abutment connecting a dental implant in a jaw of a patient with a prosthesis above said implant, said abutment comprising:
a base having a joint joinable to a protruding top joint of said implant,
at least one upwardly extending rod extending upward from said base platform, said at least one upwardly extending rod engaging said prosthesis,
said upwardly extending chimney rod joined to said prosthesis by a structural composite material supporting at least one artificial tooth thereon.

30. The dental abutment as in claim 29 wherein said upwardly extending rod is a hollow chimney accommodating a fastener therethrough, said fastener connecting said prosthesis to said implant in the jaw of the patient.

31. The dental abutment as in claim 29 wherein said at least one rod comprises a pair of rods, one of said rods structurally supporting a tooth thereon and said other rod being a hollow chimney rod accommodating a fastener therethrough, said fastener connecting said prosthesis to said implant in the jaw of the patient

32. The dental abutment as in claim 29 wherein said fastener is a double threaded fastener having male threads extending outward in opposite directions from each other.

33. A protective cap protecting an exposed portion of a dental abutment, said protective cap comprising a cup-shaped cap having a hollow interior accommodating a protruding portion of a dental abutment therein during polishing of a dental prosthesis.
